(19) United States
(12) Patent Application Publication
(10) Pub. No.: US 2013/0019979 A1
(43) Pub. Date: Jan. 24, 2013

(54) DEVICE FOR PRESSURE REDUCTION

(71) Applicants: Rolf-Harald HELMSCHROTT, Wolfratshausen (DE); Anton WELLENHOFER, Hohenschaftlarn (DE); Helmut HOENNICKE, Dresden (DE); Stefanie EPPLE, Esslingen (DE); Olof KÄLLGREN, Deisenhofen (DE); Walther AMBROS, Palladr (DE); Wolfgang DÖRNER, Munich (DE)

(72) Inventors: Rolf-Harald HELMSCHROTT, Wolfratshausen (DE); Anton WELLENHOFER, Hohenschaftlarn (DE); Helmut HOENNICKE, Dresden (DE); Stefanie EPPLE, Esslingen (DE); Olof KÄLLGREN, Deisenhofen (DE); Walther AMBROS, Palladr (DE); Wolfgang DÖRNER, Munich (DE)

(21) Appl. No.: 13/357,210

(22) Filed: Jan. 24, 2012

(30) Foreign Application Priority Data
Feb. 24, 2011 (DE) 102011012154.4

(51) Int. Cl. F16K 31/36

(52) U.S. Cl. 137/899; 137/505

(57) ABSTRACT

A device for the pressure reduction of a pressurized medium, wherein the medium is supplied to a consumer or system, which is connected downstream, after a pressure reduction has taken place and the consumer or the system, respectively, encompasses a specified design pressure. Provision is made for two pressure regulators connected in series, as well as for corresponding valves, which serve for the pressure reduction of the pressurized medium. A mobile transport device, which encompasses such a device, is further proposed.

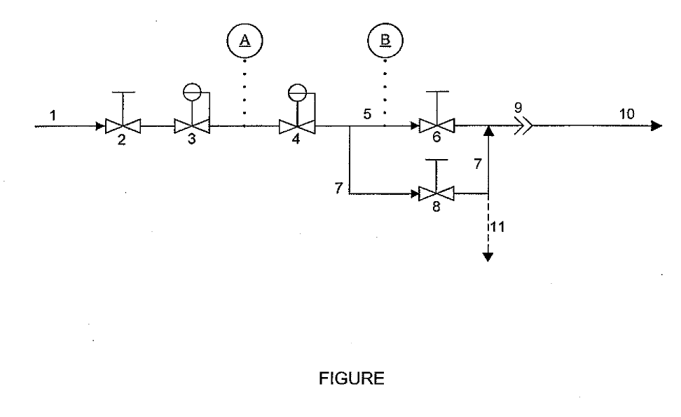

### CROSS REFERENCE TO RELATED APPLICATIONS

This application claims priority from German Patent Application No. 102011012154.4, filed Feb. 24, 2011.

### BACKGROUND OF THE INVENTION

The invention relates to a device for the pressure reduction of a pressurized medium, wherein the medium is supplied to a consumer or system, which is connected downstream, after a pressure reduction has taken place and the consumer or the system, respectively, encompasses a specified design pressure.

The invention further relates to a mobile transport device, in particular to a vehicle encompassing at least one storage device, which serves to store a pressurized medium, wherein the storage device encompasses a discharge or filling line, respectively.

Generic devices for the pressure reduction as well as generic mobile transport devices are used in response to the distribution of the most varied compressed media. The state of the art as well as the invention will be defined below by means of the example hydrogen. However, it should be emphasized that the following considerations can on principle be transferred to all other media.

In the case of the currently used hydrogen trailers, the compressed hydrogen is stored at a pressure of nominally 200 bar. The hydrogen-consuming systems or applications, respectively, of the hydrogen consumers or customers, respectively, are typically designed for a maximum pressure of 50 bar. It must thus be ensured that the hydrogen provided from a hydrogen trailer does not lead to a pressure, which is too high, to be applied to the hydrogen system of the consumer. For this reason, provision must be made for corresponding safety devices, which are currently integrated exclusively in the hydrogen system of the consumer. Well-established hydrogen trailers can thus be provided without corresponding safety devices.

Currently, it is considered to increase the pressures, at which hydrogen is transported, to up to 500 bar and more. Suitable storage devices for this are already being tested and show promising results. The change to such high pressures, however, would mean that the safety devices, which are present at the consumers, must also be designed for these high pressures, which would lead to corresponding investment costs for the hydrogen consumers.

It is the object of the instant invention to specify a generic device for the pressure reduction of a pressurized medium as well as a mobile transport device, which encompasses at least one storage device, which makes a conversion or retrofitting, respectively, of the safety devices of the consumers of the pressurized media obsolete.

### SUMMARY OF THE INVENTION

To solve this object, a device for the pressure reduction of a compressed medium is proposed, wherein the medium is supplied to a consumer or system, which is connected downstream, after a pressure reduction has taken place, and the consumer or the system, respectively, encompasses a specified design pressure. Three alternatives of the device according to the invention are thus proposed for the pressure reduction of a compressed medium.

In the first alternative, there is disclosed a device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a first pressure regulator connected downstream from the first valve,
wherein the operating pressure on the low pressure side of the first pressure regulator is adjusted to a value below the design pressure of the consumer or system, which is connected downstream,
a pressure indicator (a), which is assigned to the first pressure regulator,
a second pressure regulator, which is connected downstream from the first pressure regulator,
wherein the operating pressure on the low pressure side of the second pressure regulator is adjusted to a value below the operating pressure on the low pressure side of the first pressure regulator,
a pressure indicator (b), which is assigned to the second pressure regulator,
a second valve, which is connected downstream from the second pressure regulator, and
a bypass line, which bypasses the second valve and in which a third valve is arranged.

In the second alternative, there is disclosed a device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a first external or internal medium-controlled control valve, which is connected downstream from the first valve,
wherein the operating pressure on the low pressure side of the first control valve is adjusted to a value below the design pressure of the consumer or system, which is connected downstream,
a second external or internal medium-controlled control valve, which is connected downstream from the first control valve,
wherein the operating pressure on the low pressure side of the second control valve is adjusted to a value below the operating pressure on the low pressure side of the first control valve,
a second valve, which is connected downstream from the second control valve, and
a bypass line, which bypasses the second valve and in which a third valve is arranged.

In the third alternative, there is disclosed a device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a pressure regulator, which is connected downstream from the first valve,
wherein the operating pressure on the low pressure side of the pressure regulator is adjusted to a value below the design pressure of the consumer or system connected downstream,
a pressure indicator, which is assigned to the pressure regulator,
an external or internal medium-controlled control valve, which is connected downstream from the pressure regulator,
wherein the operating pressure on the low pressure side of the control valve is adjusted to a value below the operating pressure on the low pressure side of the pressure regulator,
a second valve, which is connected downstream from the second control valve, and
a bypass line, which bypasses the second valve and in which a third valve is arranged.

The mobile transport device according to the invention is characterized in that it encompasses at least one device according to the invention for the pressure reduction of a pressurized medium, wherein this device is assigned to the discharge or filling line, respectively, of the mobile transport device.

Further advantageous embodiments of the device according to the invention for the pressure reduction as well as of the mobile transport device according to the invention, which represent subject matters of the dependent patent claims, are characterized in that
first and/or the second pressure regulator or the pressure regulator, respectively, is/are (a) back pressure regulator,
the functions of the first valve as well as of the (first) pressure regulator are integrated in a pressure regulator,
(a) pressure indicator, preferably (a) manometer, is/are assigned to the first and/or to the second external or internal medium-controlled control valve or to the external or internal medium-controlled control valve, respectively, and
all of the valves and pressure regulators or control valves, respectively, are arranged within a control box or a valve box.

### BRIEF DESCRIPTION OF THE DRAWINGS

The device according to the invention for the pressure reduction of a pressurized medium as well as further advantageous embodiments thereof will be specified below in more detail by means of the exemplary embodiment illustrated in the FIGURE.

### DETAILED DESCRIPTION OF THE INVENTION

The embodiment illustrated in the FIGURE of the device according to the invention for the pressure reduction of a pressurized medium, such as hydrogen, for example, which is supplied to the device via a line 1, encompasses a first valve 2, which is embodied as a hand valve, for example. A first pressure regulator 3 is connected downstream therefrom. The operating pressure thereof on its low pressure side is adjusted to a value below the design pressure of the consumer or system of the pressure-reduced medium, which is connected downstream. The medium consumer or the medium system connected downstream, respectively, is not illustrated in the FIGURE for the sake of clarity. Only a transfer line 10 is illustrated, which provides for a supply of the pressure-reduced medium or hydrogen, respectively, after a connection to the device according to the invention via a coupling 9.

A second pressure regulator 4 is connected downstream from the first pressure regulator 3. The operating pressure thereof on its low pressure side is adjusted to a value below the operating pressure on the low pressure side of the first pressure regulator 3. The second pressure regulator 4 hereby serves as an additional protection of the first pressure regulator 3. A pressure indicator, for example a manometer a or b, respectively, is in each case assigned to the pressure regulators 3 and 4. The pressure regulators 3 and 4 are preferably embodied as back pressure regulators.

A second valve 6, which is preferably also embodied as a hand valve, is furthermore connected downstream from the second pressure regulator 4. The device according to the invention furthermore encompasses a bypass line 7; a third valve 8 is arranged therein. Said bypass line is also preferably embodied as a hand valve.

As an alternative to the pressure regulators 3 and 4, external or internal medium-controlled control valves can also be used. An alternative, in the case of which an external or internal medium-controlled control valve is used instead of the second pressure regulator, can further also be realized. As already mentioned, the device according to the invention for the pressure reduction of the pressurized medium, can be used in hydrogen trailers, for example. In this case, the hydrogen stored on the hydrogen trailer, which encompasses a pressure of 500 bar or more, for example, is supplied to the device according to the invention via the line 1. The mode of operation, which is to be realized by means of the device according to the invention, will be defined below.

Prior to the onset of the actual refilling process, a so-called functional test is typically carried out. The valves 2, 6 and 8 are thereby closed. The medium or hydrogen-consuming system, respectively, which is connected downstream and which is not illustrated in the FIGURE for the sake of clarity, must then be ventilated by the operating personnel. Subsequently, lines 1 and 10 are connected to one another via the coupling 9.

The valve 8 is now opened, so as to reduce a possible overpressure in the line areas 1 and/or 5 via the bypass line 7. As an alternative to this, a release into the atmosphere is also possible via the dashed line 11. As soon as the possible overpressure is reduced, the valve 8 is closed. The valve 2 is then opened (slowly) and a test is conducted by means of the manometers a and b, whether the operating pressures adjusted on the low pressure sides of the two pressure regulators 3 and 4 are maintained. Provided that this is the case, the refilling of the medium or of the hydrogen, respectively, to the hydrogen-consuming system can be started via the line sections 1, 5 and 10.

For this purpose, the reduction or ventilation valve, respectively, of the hydrogen consumer, which is not illustrated in the FIGURE, is closed and the second valve 6 is subsequently opened (slowly).

To end the refilling process, the valves 2 and 6 are closed, preferably one after the other, and the afore-mentioned discharge valve of the hydrogen consumer is opened again. The connection 9, which exists between lines 1 and 10, can be separated subsequently.

The device according to the invention for the pressure reduction of a pressurized medium does not require safety valves or burst disks. Other pressure-activated discharge devices are furthermore also not necessary. In addition, it is also not necessary to provide for additional electric energy, instrument air, etc. . . .

What we claim is:

1. A device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a first pressure regulator connected downstream from the first valve,
wherein the operating pressure on the low pressure side of the first pressure regulator is adjusted to a value below the design pressure of the consumer or system, which is connected downstream,
a pressure indicator (a), which is assigned to the first pressure regulator,
a second pressure regulator, which is connected downstream from the first pressure regulator,
wherein the operating pressure on the low pressure side of the second pressure regulator is adjusted to a value below the operating pressure on the low pressure side of the first pressure regulator,
a pressure indicator (b), which is assigned to the second pressure regulator,
a second valve, which is connected downstream from the second pressure regulator, and
a bypass line, which bypasses the second valve and in which a third valve is arranged.

2. A device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a first external or internal medium-controlled control valve, which is connected downstream from the first valve,
wherein the operating pressure on the low pressure side of the first control valve is adjusted to a value below the design pressure of the consumer or system, which is connected downstream,
a second external or internal medium-controlled control valve, which is connected downstream from the first control valve,
wherein the operating pressure on the low pressure side of the second control valve is adjusted to a value below the operating pressure on the low pressure side of the first control valve,
a second valve, which is connected downstream from the second control valve, and
a bypass line, which bypasses the second valve and in which a third valve is arranged.

3. A device for the pressure reduction of a pressurized medium, wherein the medium is supplied to a consumer or system, which is connected downstream, after a pressure reduction has taken place and the consumer or the system, respectively, encompasses a specified design pressure, characterized by
a first valve,
a pressure regulator, which is connected downstream from the first valve,
wherein the operating pressure on the low pressure side of the pressure regulator is adjusted to a value below the design pressure of the consumer or system connected downstream,
a pressure indicator, which is assigned to the pressure regulator,
an external or internal medium-controlled control valve, which is connected downstream from the pressure regulator,
wherein the operating pressure on the low pressure side of the control valve is adjusted to a value below the operating pressure on the low pressure side of the pressure regulator,
a second valve, which is connected downstream from the second control valve, and
a bypass line, which bypasses the second valve and in which a third valve is arranged.

4. The device according to claim 1, characterized in that said first and second pressure regulators are a back pressure regulator.

5. The device according to claim 2, characterized in that said first and second pressure regulators are a back pressure regulator.

6. The device according to claim 1, characterized in that the functions of the first valve and the first pressure regulator are integrated in a pressure regulator.

7. The device according to claim 3, characterized in that the functions of the first valve and the first pressure regulator are integrated in a pressure regulator.

8. The device according to claim 2, characterized in that pressure indicator, is assigned to a valve selected from the group consisting of the first external, the second external, the internal medium-controlled control valve, the external medium-controlled control valve and the internal medium-controlled control valve.

9. The device according to claim 3, characterized in that pressure indicator, is assigned to a valve selected from the group consisting of the first external, the second external, the internal medium-controlled control valve, the external medium-controlled control valve and the internal medium-controlled control valve.

10. The device according to claim 8, characterized in that the pressure indicator is a manometer.

11. The device according to claim 9, characterized in that the pressure indicator is a manometer.

12. The device according to claim 1, characterized in that all of the valves and pressure regulators and control valves are arranged within a control box or a valve box.

13. The device according to claim 2, characterized in that all of the valves and pressure regulators and control valves are arranged within a control box or a valve box.

14. The device according to claim 3, characterized in that all of the valves and pressure regulators and control valves are arranged within a control box or a valve box.

15. A mobile transport device, encompassing at least one storage device, which serves to store a pressurized medium, wherein the storage device encompasses a discharge or filling line, respectively, characterized in that the vehicle encompasses at least one device for the pressure reduction of a pressurized medium according to one of the preceding claims, wherein the device for the pressure reduction of a pressurized medium is assigned to the discharge or filling line, respectively, of the mobile transport device.

16. The mobile transport device according to claim 15, which is a vehicle.
